(19) United States
(12) Patent Application Publication
(10) Pub. No.: US 2013/0232847 A1
(43) Pub. Date: Sep. 12, 2013

(54) Large Eyelet Hook for Centering Soft Plastic Worm

(71) Applicant: William H. Klappert, Ringwood, NJ (US)

(72) Inventor: William H. Klappert, Ringwood, NJ (US)

(21) Appl. No.: 13/417,392

(22) Filed: Mar. 12, 2012

(51) Int. Cl. A01K 83/06; A01K 85/00

(52) U.S. Cl. CPC A01K 83/06; A01K 85/00
USPC 43/42.37; 43/44.4

(57) ABSTRACT

The enlarged opening at the end opposite the barb of the Large Eyelet Hook serves two purposes. On a standard hook, the eyelet is much smaller and is designed to pass only the fishing line from the fishing reel through the eyelet to secure the hook to the line. By enlarging the eyelet, the line can be attached to the hook as it was done with the smaller eyelet. In addition, the enlarged eyelet allows a soft plastic worm fishing lure to be passed through the opening. The eyelet's inside measurement has a slightly smaller cross section than the Centering Soft Plastic Worm at the widest point. As the worm is passed through the opening, it stretches, decreasing the cross section slightly, allowing the eyelet to easily seat in the recessed groove at the exact center of the specially designed worm.

### REFERENCES CITED

U.S. Patent Documents

| | | |
|---|---|---|
| 1,513,400 | October 1924 | Koski |
| 2,154,756 | April 1939 | Kvitsky |
| 2,948,983 | August 1960 | Locklear |
| 3,429,066 | February 1969 | McClellan |
| 3,736,691 | June 1973 | Gist |
| 3,839,814 | October 1974 | Sykora |
| 3,935,659 | February 1976 | McCallum |
| 4,094,087 | June 1978 | Carpenter |
| 4,422,260 | December 1983 | Perrick |
| 4,492,054 | January 1985 | Barnhart |
| 4,569,148 | February 1986 | Kemp |
| 4,642,933 | February 1987 | Brown |
| 4,744,168 | May 1988 | McClellan |
| 5,018,297 | May 1991 | Kennedy, Jr. |
| 5,022,178 | June 1991 | Carlson |
| 5,142,811 | September 1992 | Freeman |
| 5,170,579 | December 1992 | Hollinger |
| 5,301,452 | April 1994 | Roach |
| 5,881,490 | March 1999 | Richardson |
| 5,887,379 | March 1999 | Lockhart |
| 5,950,350 | September 1999 | Norton |
| 6,182,391 | February 2001 | Hubbard |
| D440275 | April 2001 | Rosenberg |
| 6,266,916 | July 2001 | Dugan |
| 6,282,831 | September 2001 | Hugunin et. al. |
| 6,327,808 | December 2001 | Zascavage |
| 6,334,273 | June 2002 | Turner et. al. |
| 6,430,866 | August 2002 | Chiaro |
| 6,578,313 | June 2003 | Knol |
| 6,691,449 | February 2004 | Hoben |
| 6,827,930 | December 2004 | Cobb |
| 6,892,490 | May 2005 | Mattlage |
| 6,895,711 | May 2005 | Nakamichi |
| 7,299,583 | November 2007 | Adams |
| 7,370,450 | May 2008 | Roos |
| 7,793,457 | September 2010 | Hogan |

### BACKGROUND OF THE INVENTION

Fish hooks date back thousands of years and the early varieties were typically hand crafted from animal bone. The shape of the present day hooks is somewhat similar in their basic curved appearance, though the effectiveness and utility has changed greatly through the millennia. The soft plastic worm on the other hand is a recent development, and although live worms have been utilized for centuries, the soft plastic worm has many advantages over the live variety, and is one of the most popular lures used today.

The Large Eyelet Hook for Centering Soft Plastic Worm is designed to be used by individuals fishing soft plastic worms in the popular “wacky style”. To fish in this manner, the fishing hook is normally passed through the approximate center of the worm, point first, allowing the soft plastic worm to hang from hook. The problem with this method of fishing the worm is two fold.

First, the structural integrity of the plastic is compromised when the point of the hook passes through the worm. The action of passing the hook point and hook shank through the worm body creates a hole in the body. After repeated casts and strikes by fish, the worm tears and eventually splits in half. These plastic sections may be consumed by the fish as they tear away from the hook, or sink to the bottom with the likelihood of being consumed by other animals in the food chain. The potential for impact on the ecosystem can be greatly decreased by limiting the number of broken soft plastic bodies entering the environment. With the Large Eyelet Hook, the hook never penetrates the worm lure's soft plastic body, therefore decreasing the propensity for the lure to tear and fall off the hook.

The second problem when fishing the worm wacky style is that the hook shank is completely exposed and visible to the fish. With the Large Eyelet Hook, the Centering Soft Plastic Worm hangs down from its own weight on each side of the hook shank, thus concealing the view of the hook from the fish. This allows for a more natural presentation, increasing its fish attracting effectiveness.

### BRIEF SUMMARY OF THE INVENTION

With the utilization of the Large Eyelet Hook for Centering Soft Plastic Worm, the useful life of the lure is increased greatly. The soft plastic worm is never structurally compromised by the insertion of the hook completely through the body. The worm is moved away from the hook point that enters into the flesh of the fish, decreasing contact with the fish's mouth and teeth. With this presentation, the hook is much less visible to the fish.

In this configuration, a soft body trailer lure can be placed on the hook, further concealing the hook and adding virtually endless possibilities in presentation. This is not possible with the standard wacky style presentation.

### BRIEF DESCRIPTION OF VIEWS

A fishing device described in the accompanying drawings form a portion of the disclosure.

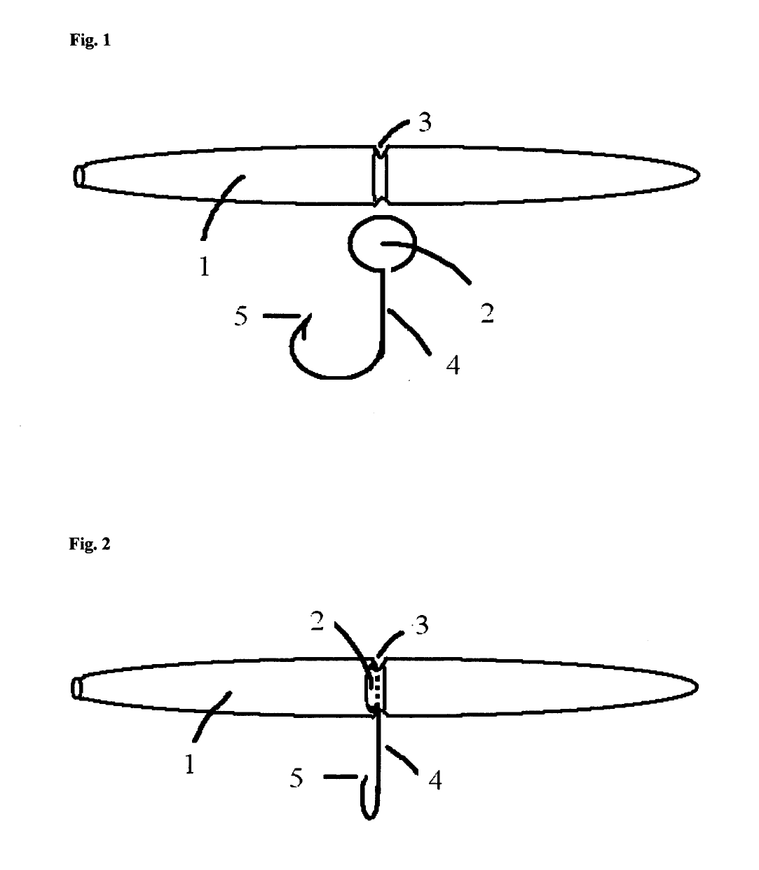

FIG. 1 Perspective view of the invention.

FIG. 2 Perspective view of the invention with the soft plastic worm inserted.

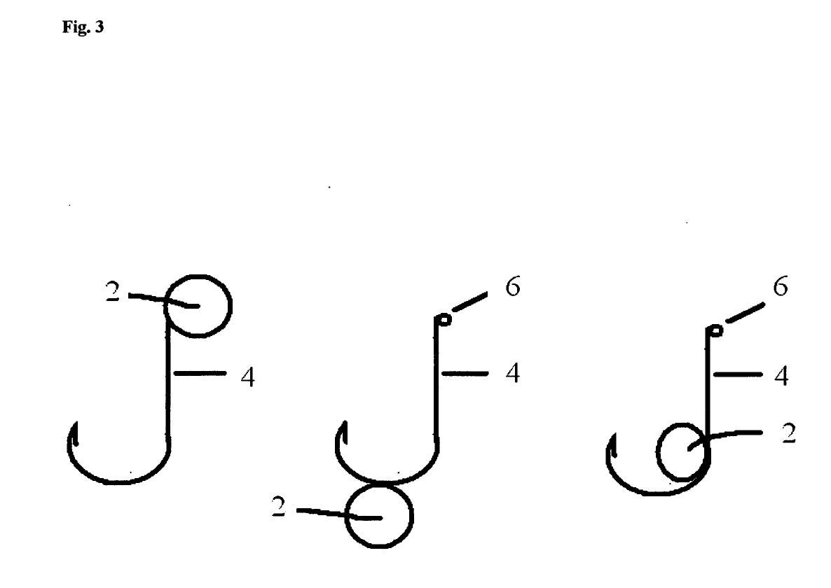

FIG. 3 Perspective view of the different hook styles.

### DETAILED DESCRIPTION OF THE INVENTION

A thorough understanding of this invention can be achieved by reference to the attached drawings. FIG. 1 details the soft plastic worm 1 with recessed groove 3 around the circumference of the worm. The enlarged eyelet 2 is part of the hook shank 4 and is on one end of the hook, opposite the point 5 at the other end of the hook.

FIG. 2 is a view of the soft plastic worm 1 inserted through the enlarged eyelet 2. The eyelet is seated in the recessed groove 3. The hook shank 4 and point 5 are also visible.

FIG. 3 exhibits the various locations that the enlarged eyelet 2 can be positioned on the hook shank 4. When the enlarged eyelet is not located at the end of the shank opposite the point, a standard sized eyelet 6 will be utilized.

1. A device for catching fish, consisting of:
A fishing hook design which incorporates a unique method of attaching a soft plastic worm lure to the fishing hook for casting and retrieving without damaging the fishing lure. The typical method of fishing with a soft plastic worm is for the angler to pass a hook completely through the body at the lure's approximate midpoint. This hole in the worm lure creates a weak area in the soft plastic, resulting in the worm lure tearing at that point after repeated casts and strikes by fish.
This unique hook design has an eyelet formed on the end of the shank of the hook, opposite the point. This eyelet is larger than the diameter of the standard eyelet. The standard eyelet is only large enough to pass a fishing line from the reel through the eyelet to secure the hook to the line with a knot. The new design still allows the line to be attached to the hook through the eyelet, but the larger diameter eyelet also accommodates the soft plastic worm. A second method of hook production would be to manufacture the hook in a mold which incorporates an eyelet in the hook mold at a point along the hook shank or hook bend, large enough to accommodate the cross section of the soft rubber worm at the recessed mid point.

2. This invention has the unique feature to allow the lure to be held on the hook by inserting it through the eyelet without damage to the soft plastic body. At the exact midpoint of the body, a recessed groove is molded into the worm around the circumference of the lure. This allows the eyelet to seat within the groove, holding it firmly in place without puncturing a hole in the lure. This method allows the lure to be perfectly balanced for casting and retrieving.

3. The location of the eyelet will enhance the longevity of the soft plastic body because the eyelet is away from the location where the hook penetrates the fish's mouth. This will eliminate the tearing and abrasion that normally occurs when landing the fish.
